(19) United States
(12) Patent Application Publication
(10) Pub. No.: US 2003/0136104 A1
(43) Pub. Date: Jul. 24, 2003

(54) ROTARY ENGINE

(76) Inventor: Ralph A. Davis, Wichita, KS (US)

Correspondence Address: Richard C. Litman, LITMAN LAW OFFICES, LTD., P.O Box 15035, Arlington, VA, 22215, US

(21) Appl. No.: 10/052,811

(22) Filed: Jan. 23, 2002

(51) Int. Cl. F02C 3/30

(52) U.S. Cl. 60/39.55; 60/805

(57) ABSTRACT

The rotary engine is an expansion fluid turbine for supplying power to lawn mowers, small vehicles, electrical generators, and the like. Fuel and oxygen are supplied from bladder tanks to combustion chamber, while water is supplied to an annular sleeve surrounding the combustion chamber in a mist by a spray nozzle. Ignition of the fuel-oxygen mixture by a glow plug heats the mist to supply steam for turning a rotor. The rotor has a circular top plate with a plurality of pin diffusers depending from its lower surface, and an annular bottom plate with a plurality of pin diffusers attached to its upper surface. A swirl pan has a flange on which the lower plate seats, and defines a swirl chamber. The steam enters the swirl chamber through a bifurcated intake conduit. Swirling in one direction causes rotation, while swirling in the opposite direction causes braking.

### BACKGROUND OF THE INVENTION

1. Field of the Invention

The present invention relates to a rotary engine or expansion fluid turbine powered by a fluid, such as gas and steam, having a novel rotor.

2. Description of the Related Art

The internal combustion engine is ubiquitous in today's society, being used to power vehicles, lawnmowers, emergency electricity generators, and the like. Nevertheless, the internal combustion engine has several drawbacks, including a large number of moving parts which increase the cost of manufacture, maintenance and repair; seals and lubrication for the moving parts; high operating temperature and pressure; high ambient noise level; and the adverse affects of exhaust emissions on the environment. Steam engines and turbines offer an alternative, but the problem with steam turbines is to develop an efficient engine which generates sufficient horsepower to drive a load without requiring a large power plant for producing the steam required. Several patents have been directed towards improving the efficiency of steam turbines and rotary engines driven by fluids.

U.S. Pat. No. 350,362, issued Oct. 5, 1886 to E. J. Hawley, shows a centrifugal pump having a piston mounted on a rotating shaft, the piston having two faces which are spaced apart by arcuate arms which spiral radially outward, increasing in width from the center to the periphery, which define waterways that permit gritty water to move outward to a removable filter lining, and thence to an outlet. U.S. Pat. No. 461,565, issued Oct. 20, 1891 to Bookwalter et al., describes a water wheel with buckets on both sides of the rim. A nozzle provides a jet of water which is split by a wedge shaped blade to divert the stream to both rows of buckets in order to drive the wheel.

U.S. Pat. No. 521,713, issued Jun. 19, 1894 to G. M. Hopkins, discloses a steam turbine having a disk shaped wheel with a slot defined about its circumference and having radial wings, a nozzle directing steam and air into the slot against the radial wings to rotate the wheel. U.S. Pat. No. 858,635, issued Jul. 2, 1907 to E. J. St. Croix, teaches a wheel mounted on a shaft and disposed in a casing, the wheel having radial blades which are Z-shaped in cross section. Inlet and outlet valves are used to direct the flow of fluid through the blades, the direction of rotation of the wheel being reversed by reversing the direction of fluid flow.

U.S. Pat. No. 1,362,853, issued Dec. 21, 1920 to L. A. Darling, shows a turbine wheel with buckets about its rim between spaced apart plates. U.S. Pat. No. 1,793,179, issued Feb. 17, 1931 to Lanterman et al., describes a two stage steam turbine having a high pressure end and a low pressure end. The rotor has a series of discs mounted in parallel, each disc having two plates joined back to back with the outer surface of each plate having buckets or cups extending radially. Steam is introduced against the edge of the discs in the high pressure end and expands into the low pressure end.

U.S. Pat. No. 1,852,197, issued Mar. 27, 1934 to O. N. Davis, teaches a rotary engine having a rotor with annularly spaced inner and outer rims with septum walls separating the rims and defining passageways. The space between the inner and outer rim is curved and increases in cross sectional diameter from inside to outside. Nozzles in the stator inject fluid (steam, air, combustion gases) into the space between the rims. U.S. Pat. No. 2,780,436, issued Feb. 5, 1957 to H. T. Holzworth, shows a novel design of a nozzle for a nozzle plate.

U.S. Pat. No. 2,923,526, issued Feb. 2, 1960 to G. Street, Jr., describes a turbine with a stator housing having a divergent outlet and a cylindrical chamber. A movable plunger is mounted in the outlet, with the rotor behind the plunger. Moving the plunger changes the outlet nozzle characteristics. U.S. Pat. No. 3,586,867, issued Jun. 22, 1971 to A. Maillet, teaches a turbine with a stator mounted on a shaft with a transverse rotor shaft mounted on the stator shaft. Rotors are mounted on the rotor shaft and have gear teeth which engage a track. A conduit directs steam against vanes on the rotor.

U.S. Pat. No. 3,879,949, issued Apr. 29, 1975 to Hays et al., discloses the use of a first phase (liquid) and a 2nd phase (vaporizable fluid) to impact the blades of a turbine rotor. U.S. Pat. No. 4,232,991, issued Nov. 11, 1980 to J. M. Gamell, shows an annular rotor having a roughened surface which is propelled by a high pressure fluid jet directed against the roughened surface of the rotor.

U.S. Pat. No. 4,355,949, issued Oct. 26, 1982 to J. M. Bailey, describes a turbine system with a speed sensor and a nozzle having internal flow diverters to divert the flow of fluid issuing from the nozzle to control velocity. U.S. Pat. No. 4,491,276, issued Jan. 1, 1985 to C. C. Reeves, discloses a pneumatic electrostatic spray gun which uses air directed in one direction to turn a rotor, and air flow in the opposite direction for braking the rotor in order to control the speed of rotation.

U.S. Pat. No. 5,072,623, issued Dec. 17, 1991 to J. A. Hendershot, shows a bladder containment system for fuel tanks and the like having a rigid housing with a first flexible bladder inside the tank and a second flexible bladder inside the first with a vacuum monitoring system for evacuating space between the bladders. U.S. Pat. No. 5,181,378, issued Jan. 26, 1993 to J. A. Devine, Jr., teaches a vapor generating source having a combustion chamber receiving fuel and air which is ignited by a glow plug to heat liquid in mist form into a vapor which is directed to a transmission means for powering a motor. Exhaust gases from combustion are collected from the transmission and used in a heat exchanger to heat a liquid source into a mist which is then condensed, cooled in a radiator, and recycled.

U.S. Pat. No. 5,275,533, issued Jan. 4, 1994 to P. D. Kapich, describes a low noise fan driven by compressed air having turbine blades and fan blades on the same hub, and having muffler plates for reducing noise. U.S. Pat. No. 5,277,542, issued Jan. 11, 1994 to Nakanishi, teaches a turbine for a turbocharger in which a spiral partition is formed on the outer periphery of a rotor with a large number of blades between the turns on the partition.

U.S. Pat. No. 5,558,721, issued Sep. 24, 1996 to Kohmura et al., discloses a vapor phase growth system that uses a gas powered motor to turn wafers. U.S. Pat. No. 6,196,793, issued Mar. 6, 2001 to M. E. Bratten, shows a nozzle box mounted to a shaft to improve fluid flow in a turbine. U.S. Pat. No. 6,233,942, issued May 22, 2001 to W. P. White, teaches a turbine with no condenser and pump, the turbine having a drum and fluid exit ports for ejecting fluid as high pressure liquid so that the turbine also acts as a positive displacement pump.

None of the above inventions and patents, taken either singularly or in combination, is seen to describe the instant invention as claimed. Thus a rotary engine solving the aforementioned problems is desired.

### SUMMARY OF THE INVENTION

The rotary engine is an expansion fluid turbine for supplying power to lawn mowers, small vehicles, electrical generators, and the like. Fuel and oxygen are supplied from bladder tanks to a combustion chamber, while water is supplied to an annular sleeve surrounding the combustion chamber in a mist by a spray nozzle. Ignition of the fuel-oxygen mixture by a glow plug heats the mist to supply steam for turning a rotor. The rotor has a circular top plate with a plurality of pin diffusers depending from its lower surface, and an annular bottom plate with a plurality of pin diffusers attached to its upper surface. A swirl pan has a flange on which the lower plate seats, and defines a swirl chamber. The steam enters the swirl chamber through a bifurcated intake conduit. Swirling in one direction causes rotation, while swirling in the opposite direction reverses rotation or causes braking. Steam condensate is recirculated by a pump to maintain pressure on the bladder tanks.

Accordingly, it is a principal object of the invention to provide a rotary engine which is a practical quiet engine of the expansion fluid turbine type having one rotating assembly.

It is another object of the invention to provide an expansion fluid turbine with a controllable power output at various revolutions per minute with braking and reversing capabilities.

It is a further object of the invention to provide an efficient rotary engine with minimal production and operating costs.

Still another object of the invention is to provide a rotary engine of the expansion fluid turbine type which provides a clean, non-polluting source of power.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a diagrammatic view of a rotary engine according to the present invention.

FIG. 2 is an exploded perspective view of a turbine rotor according to the present invention.

FIG. 3 is a section view along the lines 3-3 of FIG. 1.

FIG. 4 is a perspective view of the swirl pan, showing an alternative embodiment of the intake conduit.

Similar reference characters denote corresponding features consistently throughout the attached drawings.

### DETAILED DESCRIPTION OF THE PREFERRED EMBODIMENTS

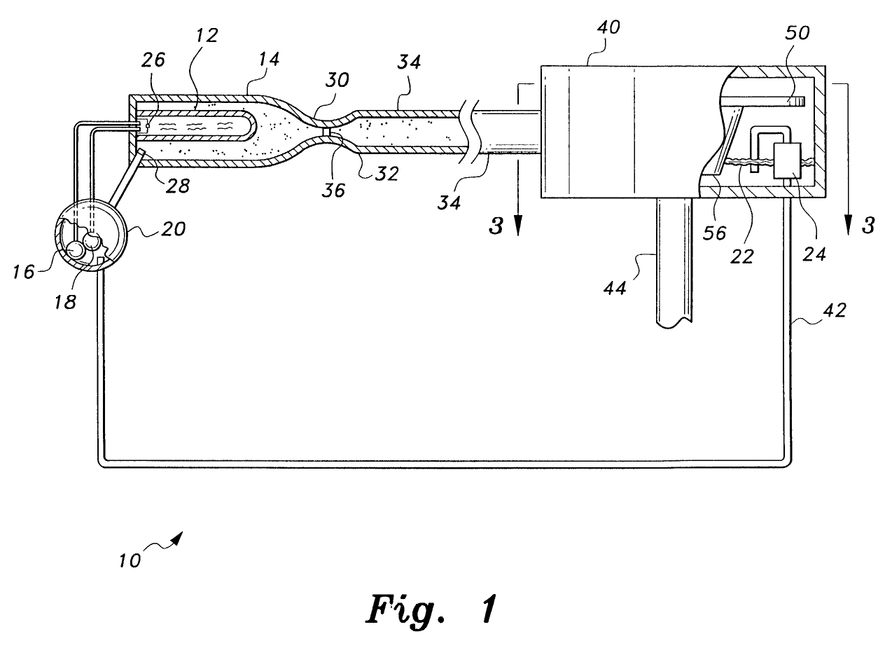

The present invention is a rotary engine for supplying power to a lawnmower, small vehicle, emergency electrical generator, etc. As shown diagrammatically in FIG. 1, the rotary engine 10 includes a combustion chamber 12 surrounded by a bottle-shaped enclosure 14 or sleeve. The combustion chamber 12 is supplied with fuel and oxygen or air by deflatable, bladder-type fuel and oxygen tanks 16 and 18, respectively. The fuel tank 16 and the oxygen tank 18 are disposed in a water reservoir 20 which is supplied with water to maintain external pressure on the bladder tanks 16 and 18, thereby pressurizing the fuel supply. The fuel and oxygen from nozzle 26 mix in the combustion chamber 12. Water from the reservoir 20 is supplied to the annular space between the enclosure 14 and the combustion chamber 12 by a spray nozzle 28 which forms a mist. The enclosure 14 converges to a neck 30 before diverging to form a pressure manifold 32 joined to the turbine's intake conduit 34. The neck 30 has a variable orifice which may be defined by a valve 36 having a movable diaphragm to widen or narrow the orifice.

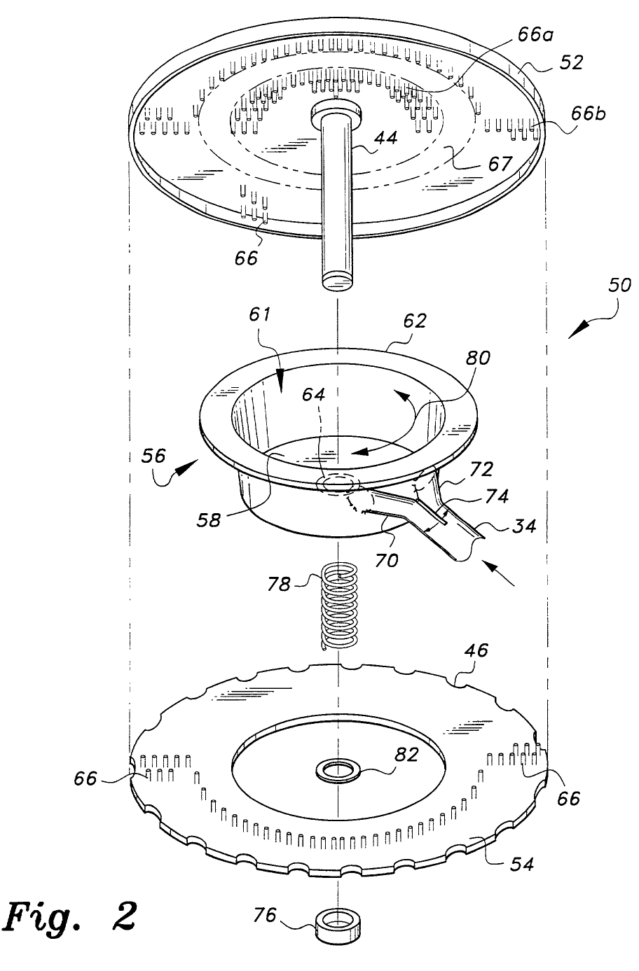

The turbine's intake conduit 34 passes through a turbine casing 40. A discharge tube or outlet pipe 42 exits the turbine casing 40, and is connected to the water reservoir 20. A pump 24 disposed in the casing 40 is used to recycle water (steam condensate) used to drive the turbine in order to pressurize the fuel cells 16 and 18, the water being filtered by membrane filter 22. A rotatable power shaft 44 extends transversely through the turbine casing 40 and is connected by a transmission means to a load (not shown). Fuel and air mix in the combustion chamber 12, entering through the mixing nozzle 26, and are ignited by a glow plug (not shown). Heat in the combustion chamber 12 reaches approximately 1500° F., and the walls of the combustion chamber 12 conduct heat so that the exterior surface of the walls reaches a temperature of about 350° F., causing the water mist to explode into steam seventeen hundred times in size. A mixture of combustion gases and steam pass through the variable orifice 36 in the neck of the enclosure and pressure manifold 32 to the swirl chamber 61 (seen in FIG. 2). The majority of the combustion gases and steam are forced by pressure into the conduit 34 to drive the turbine. The steam expands radially through the rotor assembly 50 and condenses and passes through openings 46 defined in the periphery of the lower plate 54 of the rotor 50 and membrane filter 22 and is recirculated by pump 24 to the water reservoir 20 to maintain pressure on the fuel cells 16 and 18.

Disposed within the turbine casing 40 is a water pump 24, I membrane filter 22, and a novel rotor assembly 50, shown in FIG. 2. The rotor 50 comprises an upper plate 52 and a lower plate 54 which are fixedly attached to each other. The upper plate 52 is a circular plate, the power shaft 44 extending through the center of the upper plate 52 and being fixed thereto in order to rotate with the upper plate 52. The lower plate 54 is an annular ring having the same diameter as the upper plate 52, and has openings 46 defined about its periphery to allow steam condensate to escape into the turbine casing 40. The rotor 50 receives velocity from a swirl pan 56 having a bottom 58 and a cylindrical or frusto-conical sidewall 60 defining a swirl chamber 61. A flange 62 extends normal to and about the upper periphery of the sidewall 60. The shaft 44 extends through the center of the bottom wall 58 and is supported for rotation by a bearing 64. Swirl pan 56 is fixed to intake conduit 34 and casing 40 so that it does not rotate, the flange 62 being sandwiched between the upper plate 52 and the lower plate 54 with the sidewall 60 extending through the central opening defined in the lower plate 54. An adjustable retainer ring 76 is fixed to the shaft 44 below swirl pan 56.

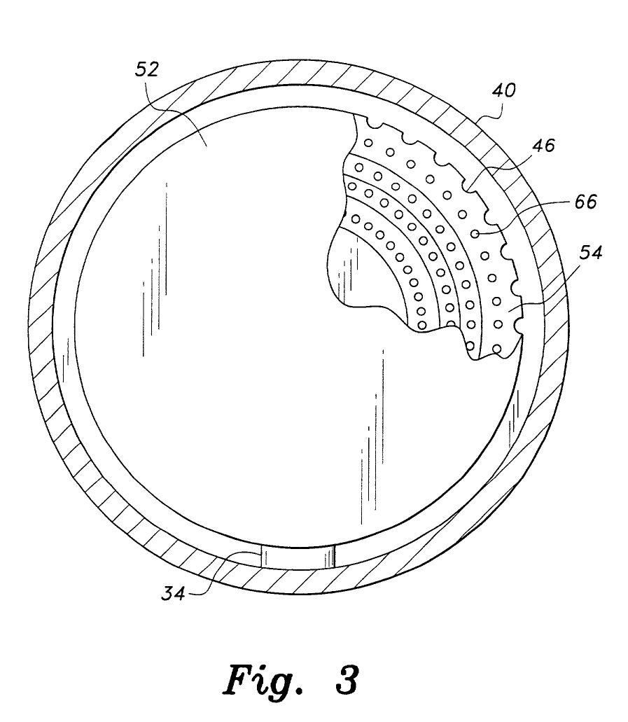

The rotor 50 has a plurality of pin diffusers 66 or projections disposed between the upper plate and the lower plate 54. The pin diffusers 66 are preferably cylindrical in shape, and extend radially outward in a symmetrical pattern of concentric circles, as seen in FIG. 3, defining a plurality of circular passages of progressively increasing radius. The pin diffusers depending from the upper plate 52 are divided into an inner section 66a and an outer section 66b by an annular zone 67 sized and dimensioned for seating the upper plate 52 on the flange 62. The pin diffusers 66 may be disposed only on the upper plate 52, on both the upper 52 and lower 54 plates, or may extend between the upper 52 and lower 54 plates, as by rivets attaching the upper plate 52 to the lower plate 54.

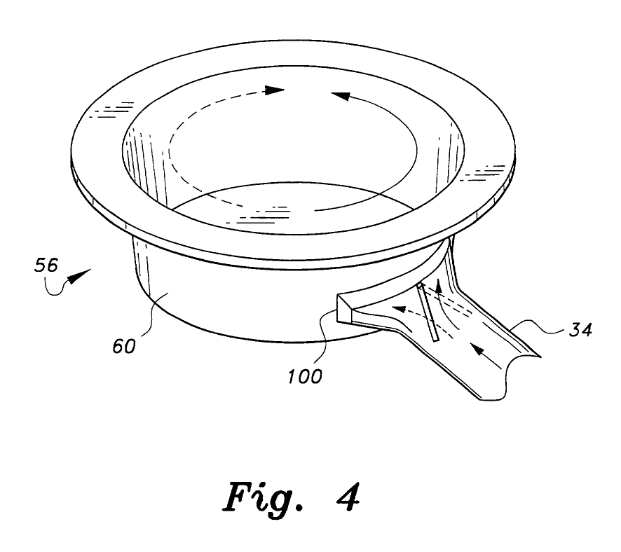

Fluid is supplied to the swirl pan 56 by an intake conduit 34. As shown in FIG. 2, the intake conduit 34 may bifurcate proximate its junction with the sidewall 60 of the swirl pan 56 into a first branch 70 which directs the fluid through the sidewall 60 into the swirl chamber 61 in a generally clockwise swirling pattern, and a second branch 72 which directs the fluid through the sidewall 60 in a generally counterclockwise swirling pattern, as indicated by the bidirectional arrow 80. Flow through the two branches 70 and 72 is controlled by a sliding or swinging gate valve 74, which can be controlled to completely block the flow of fluid from the intake conduit 34 into one or the other branch 70 and 72, or to partially block the flow in one branch and admit the flow into the other branch in continuous fashion. Alternatively, intake conduit 34 may terminate in a generally pyramidal manifold 100 attached to the sidewall 60 of the swirl pan 56, with the gate valve 74 disposed in the mouth of the manifold to direct flow in a counterclockwise direction when the valve 74 is positioned as shown in solid lines in FIG. 4, or in a clockwise direction when positioned as shown in dashed lines in FIG. 4.

In operation, with no fluid pressure applied, upper plate 52 seats on flange 62 of swirl pan 56 by gravity. As steam and hot combustion gases are applied through one branch 70 or 72 of the intake conduit 34, a swirl pattern (either clockwise or counterclockwise) develops in the swirl pan 56. As the steam impinges on the pin diffusers 66a, the upper plate 52 and lower plate 54 begin to rotate, turning shaft 44. As the volume of steam and combustion gases increases and pressure builds, the upper plate 52 “floats” or rises off the flange 62, causing the lower plate 54 to rise with it. The steam and combustion gases swirl through the diffuser pins 66 in a circular path, expanding radially outward from the inner section of diffuser pins 66a through the outer section of diffuser pins 66b. The gap between the flange 62 and the upper plate 52 creates a venturi effect, increasing the velocity of the swirl.

When increased power is required, the internal fluid pressure in the swirl chamber 61 is regulated by the adjustable retainer 76 which is used to adjust the gap between the flange 62 and the upper plate 52 in order to increase the velocity directed to the outer diffuser pins 66b. The retainer 76 may be a two piece structure with an upper half, a lower half, and a compression spring disposed between to two halves, or there may be an external compression spring 78 concentric with the shaft 44 disposed between the bottom 58 of the swirl pan 56 and the retainer 76 and abutting a washer 82 or other bearing surface. When the rotor assembly 50 rises, the spring 78 is compressed, and when the fluid pressure is decreased, the spring 78 expands to return the upper plate 52 to its seat on the flange 62.

When an increased torque is required for a heavy load, increasing the fluid volume by adjusting the valve 36 to widen the variable orifice increases the number of pins loaded for power output. Centrifugal force plays a part in lowering the pressure on the downwind side of the pins. Exhaust gases and steam condense at the periphery of the upper 52 and lower plates 54, and is exhausted through outlet pipe 42.

When it is desired to decrease the speed of revolution, the position of the sliding or swinging gate valve 74 may be adjusted to reduce the flow in the original direction of rotation and to induce a counter flow in the opposite direction, thereby slowing rotation, and the volume of fluid may be reduced by adjusting valve 36 to narrow the variable orifice. As rotation slows and pressure within the swirl chamber 61 decreases, the upper plate 52 lowers into frictional contact with the flange 62, thereby helping to brake the rotor 50. When it is desired to reverse the direction of rotation, the sliding valve 74 may be moved to block the original inlet branch 70 or 72 and to open the opposite branch 70 or 72.

The temperature of the combustion chamber should be maintained between 350° and 400° F., controlled by a heat sensor which sends control signals to a fuel flow valve. Water spray from the reservoir 20 is added or reduced as needed to control power. The rotary engine of the present invention is estimated to be capable of producing power double to that of a comparable reciprocating internal combustion engine operating at the same rpm, while producing a lower volume of environmental pollutants and having decreased construction and maintenance costs due to the single rotating structure.

It is to be understood that the present invention is not limited to the embodiments described above, but encompasses any and all embodiments within the scope of the following claims.

I claim:

1. A rotary engine, comprising:
(a) fluid generating means for generating a fluid;
(b) an intake conduit for receiving the fluid;
(c) a turbine casing connected to said intake conduit;
(d) a rotor assembly disposed within said turbine casing, having:
(i) a circular upper plate;
(ii) an annular lower plate;
(iii) a swirl pan having a bottom wall and a sidewall defining a swirl chamber, and having a flange extending normal to and about an upper periphery of the sidewall, said upper plate and said lower plate being connected together with the flange disposed between said upper plate and said lower plate and the sidewall extending through said annular lower plate;
(iv) a power output shaft extending through the center of said circular upper plate and through the bottom wall of said swirl pan;
(v) an adjustable retainer ring disposed on said shaft below said swirl pan;
(vi) a plurality of diffuser pins symmetrically disposed between said upper plate and said lower plate defining a plurality of circular passages of progressively increasing radius;
(vii) said intake conduit being connected between said fluid generating means and the sidewall of said swirl pan; and
(viii) a valve disposed in said intake conduit for regulating inflow of fluid to said swirl pan, the valve having a first position for directing the flow of steam into said swirl pan in a clockwise direction, and a second position for directing the flow of steam into said swirl pan in a counterclockwise direction;
wherein the upper plate is seated on said flange at low pressure, and rotates and rises above said flange as fluid pressure and volume increase.

2. The rotary engine according to claim 1, wherein each of said diffuser pins is cylindrical in shape.

3. The rotary engine according to claim 1, further comprising means for regulating the volume of fluid admitted into said intake conduit.

4. The rotary engine according to claim 1, wherein said fluid comprises steam.

5. The rotary engine according to claim 1, wherein said fluid comprises a mixture of steam and combustion gases.

6. The rotary engine according to claim 1, wherein said fluid generating means comprises:
(a) a pressurized water reservoir;
(b) a bladder fuel tank disposed in said water reservoir;
(c) a bladder gas tank containing a combustible gas;
(d) an enclosure having a neck and a pressure manifold opening into said intake conduit;
(e) a combustion chamber disposed in said enclosure and defining an annular space between the combustion chamber and said enclosure;
(f) a nozzle connected to said fuel tank and said gas tank, and opening into said combustion chamber for introducing both fuel and combustible gas into said combustion chamber; and
(g) a spray nozzle connected to said water reservoir and opening into the annular space between said combustion chamber and said enclosure for introducing a spray mist of water into said annular space.

7. The rotary engine according to claim 6, further comprising a valve disposed in the neck of said enclosure defining a variable orifice for controlling a volume of fluid passing from said enclosure to said intake conduit.

8. The rotary engine according to claim 1, further comprising means for adjustably positioning said retainer ring on said shaft in order to control a gap between the flange on said swirl pan and said upper plate.

9. The rotary engine according to claim 1, further comprising a compression spring resiliently biasing said retainer ring on said shaft.

10. The rotary engine according to claim 1, wherein said plurality of diffuser pins are disposed in concentric circles of progressively increasing radius.

11. The rotary engine according to claim 1, wherein said plurality of diffuser pins includes a inner section of diffuser pins depending from said upper plate above said swirl pan and an outer section of swirl pins disposed between said upper plate and said lower plate, the inner section and the outer section being divided by an annular zone characterized by an absence of diffuser pins for seating the flange of said swirl pan.

12. The rotary engine according to claim 1, further comprising an outlet pipe connected to said turbine casing for exhaust of combustion gases, steam, and condensation products.

13. An expansion fluid turbine rotary engine, comprising:
(a) a fuel supply;
(b) a combustion chamber connected to said fuel supply;
(c) a pressurized water reservoir;
(d) a sleeve surrounding said combustion chamber and defining an annular space therebetween;
(e) means for supplying water from said water reservoir to the annular space between said combustion chamber and said sleeve in a mist;
(f) an intake conduit connected to said sleeve;
(g) volume regulating means for adjusting fluid volume transferred from said sleeve to said intake conduit;
(h) a turbine having:
(i) a swirl pan connected to said intake conduit and having a flange;
(ii) a rotor having an upper plate and a lower plate sandwiched around the flange of said swirl pan, the rotor being rotatable about the swirl pan;
(iii) a power output shaft attached normal to the upper plate and extending through said swirl pan, the rotor being rotatable in a plane normal to said shaft, the plane being movable on an axis through said shaft, whereby said rotor floats on the flange of said swirl pan.

14. The expansion fluid turbine rotary engine according to claim 13, wherein said fuel supply comprises:
(a) a bladder-type fuel tank disposed within said water reservoir;
(b) a bladder-type oxygen tank disposed within said water reservoir;
whereby said fuel supply is pressurized when said water reservoir contains sufficient water to submerge said bladder-type tanks.

15. The expansion fluid turbine rotary engine according to claim 13, wherein said means for supplying water comprises a spray nozzle opening into the annular space defined by said sleeve and said combustion chamber.

16. The expansion fluid turbine rotary engine according to claim 13, further comprising a valve disposed between said sleeve and said intake conduit for controlling fluid volume supplied to said intake conduit.

17. The expansion fluid turbine rotary engine according to claim 13, wherein said intake conduit has a bifurcated end including a first branch oriented to introduce fluid into said swirl pan with a clockwise swirl pattern, and a second branch oriented to introduce fluid into said swirl pan with a counterclockwise swirl pattern, said intake conduit further including a valve disposed therein for regulating flow between the first branch and the second branch in order to brake and reverse rotation of said rotor.

18. The expansion fluid turbine rotary engine according to claim 13, further comprising a plurality of pin diffusers concentrically disposed between the upper plate and the lower plate of said rotor in order to define a plurality of circular flow paths of increasing radius.

19. The expansion fluid turbine rotary engine according to claim 18, further comprising a plurality of pin diffusers depending from the upper plate above said swirl pan and defining an inner section of pin diffusers, the inner section being surrounded by an annular zone lacking diffusers for seating the flange on said swirl pan, the flange braking rotation of said rotor.

20. The expansion fluid turbine rotary engine according to claim 13, wherein said sleeve has a neck disposed between said combustion chamber and said intake conduit, said volume regulating means comprising a valve disposed in the neck for adjusting the diameter of the neck.
